(19) United States
(12) Patent Application Publication
(10) Pub. No.: US 2015/0220860 A1
(43) Pub. Date: Aug. 6, 2015

(54) METHOD AND A SYSTEM FOR OPTIMAL DEBT COLLECTION

(71) Applicant: WIPRO LIMITED, Bangalore (IN)

(72) Inventors: Vijay Rao Perepa, Hyderabad (IN); Venkatakrishnan Rajaram, Bangalore (IN); Arpith Pookat Rammohan, Calicut (IN)

(73) Assignee: WIPRO LIMITED, Bangalore (IN)

(21) Appl. No.: 14/230,458

(22) Filed: Mar. 31, 2014

(30) Foreign Application Priority Data
Feb. 5, 2014 (IN) 540/CHE/2014

(51) Int. Cl. G06Q 10/06

(52) U.S. Cl. CPC G06Q 10/0633; G06Q 50/06

(57) ABSTRACT

Disclosed herein are a method and a system for optimizing the process of debt collection. The method comprises: identifying a customer with a debt; classifying the customer with the debt into one of a plurality of predefined categories based on a profile of the customer; retrieving one or more category specific collection actions capable of being taken against the customer based on the category associated with the customer; determining a historic probability of success and/or failure for the one or more category specific collection actions; generating, by a processor, a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows; determining an optimal workflow from the one or more workflows on basis of maximum expected value at the source node, the maximum expected value based on cost associated with the one or more category specific collection actions and probability of success and/or failure of the one or more category specific collection actions.

This application claims the benefit of Indian Patent Application Filing No. 540/CHE/2014, filed Feb. 5, 2014, which is hereby incorporated by reference in its entirety.

### FIELD OF THE INVENTION

This disclosure relates generally to water utility entities, and more particularly to method and system for optimal debt collection from a customer.

### BACKGROUND OF THE INVENTION

In most of the countries, non-payment of water bills poses a serious challenge to water utility entities in terms of debt management. This challenge is further compounded by fact that the regulatory bodies do not permit disconnection of services of domestic or households for the non-payment of water bills. Cost of revenue collections constitutes a significant component of retail services cost of the water utility entities. Amount spent on collection actions directly impacts margin of the water utility entities.

Collection actions that are undertaken by the water utility entities are governed by guidelines mandated by regulators, for example, soft reminders should be sent to customers before sending legal notices or passing the debt to outside agencies for collections, certain numbers of days have to be given to customers before initiating collection actions. The cost of the collection increases with later stages of collection actions and each collection action involves a cost. Further, outcome of the collection actions is uncertain and the water utilities have to perform a series of collections to get money from the customer. The amount spent on collection actions is wasted if the outcome does not lead to realization of the payment by the customer. The water utility entities have to decide at what point it is not worth chasing and decide to write off the debt.

Therefore, in view of above drawbacks, there is a need for a water utility entity to optimize the process of debt collection so as to maximize the margins.

### SUMMARY OF THE INVENTION

Disclosed herein is a method performed by a utility providing entity for optimizing debt collection from a customer, the method includes a identifying a customer with a debt; classifying the customer with the debt into one of a plurality of predefined categories based on a profile of the customer; retrieving one or more category specific collection actions capable of being taken against the customer based on the category associated with the customer; determining a historic probability of success and/or failure for the one or more category specific collection actions; generating, by a processor, a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows; determining an optimal workflow from the one or more workflows on basis of maximum expected value at the source node, the maximum expected value based on cost associated with the one or more category specific collection actions and probability of success and/or failure of the one or more category specific collection actions.

In an aspect of the invention, a system for optimizing debt collection from the customer is disclosed. The system includes at least one processor; a memory coupled to the at least one processor, the memory storing instructions which when executed by the processor causes the processor to: identify a customer with a debt; classify the customer with the debt into one of a plurality of predefined categories based on a profile of the customer; retrieve one or more category specific collection actions capable of being taken against the customer based on the category associated with the customer; determine a historic probability of success and/or failure for the one or more category specific collection actions; generate a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows; determine an optimal workflow from the one or more workflows on basis of maximum expected value at the source node, the maximum expected value based on the cost associated with the one or more category specific collection actions and the historic probability of success and/or failure of the one or more category specific collection actions.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an environment in which a water utility entity interacts with customer in accordance with some embodiments.

FIG. 2 a flowchart for optimizing process of outstanding debt collection in accordance with some embodiments.

FIG. 3A-3C illustrates method of classification of the customer in one of a plurality of categories.

FIG. 4 is an exemplary workflow comprising collection actions in accordance with some embodiments.

FIG. 5 is a block diagram of a system for optimizing process of outstanding debt collection in accordance with some embodiments.

FIG. 6 is a block diagram of an exemplary computer system for implementing embodiments consistent with the present disclosure.

### DETAILED DESCRIPTION OF THE INVENTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

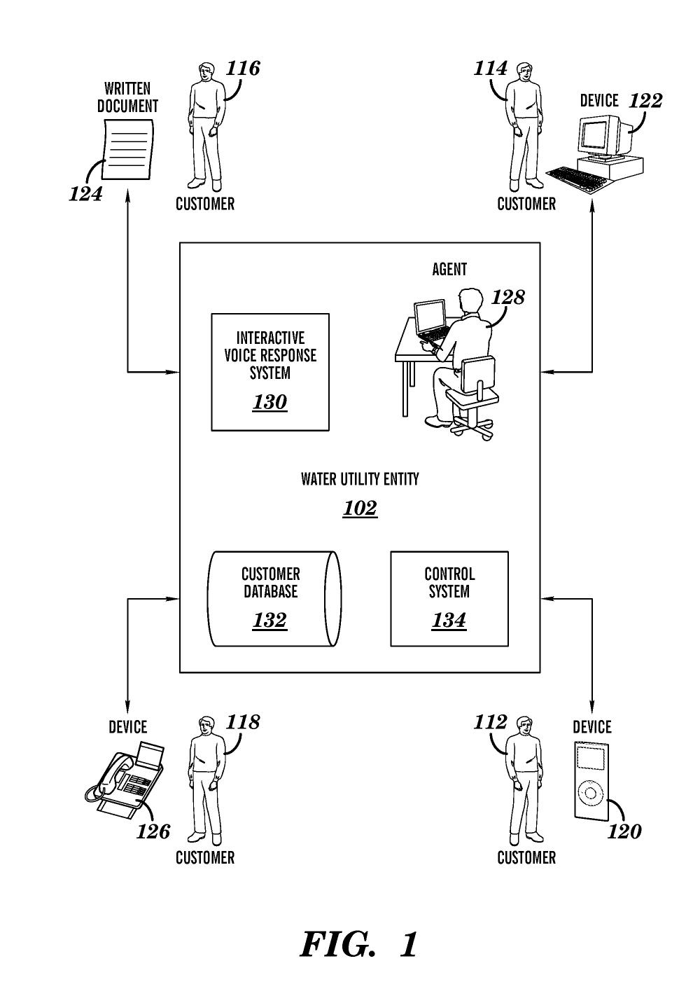

FIG. 1 illustrates an environment in which a water utility entity interacts with various customers in accordance with some embodiments. A water utility entity 102 as illustrated in FIG. 1 may interact with various customer entities that receive water utility services from water utility entity 102. For purposes of this disclosure, a customer may include a single customer who receives water utility services from the water utility entity 102. However, it should be understood that a customer may include an organization, a company, or a household that interacts with the water utility entity 102.

In some embodiments, the water utility entity 102 may interact with various customers such as customer 112, customer 114, customer 116, and customer 118 and vice versa. For exemplary purposes, FIG. 1 illustrates that customer 112 may interact with the water utility entity 102 by using a device 120. Device 120 may be a mobile device, a handheld device, a tablet, or any other electronic device that is capable of conducting audio and/or video calling with an agent 128 associated with the water utility entity 102, interacting with an interactive voice response (IVR) response system 130 associated with the water utility entity 102, sending SMS, running an internet browsing functionality and/or sending electronic mails (e-mail) to water utility entity 102. Further, another customer 114 may communicate with water utility entity 102 by using a device 122. Device 122 may include a desktop computer, a workstation, a laptop, or a tablet personal computer (PC). Device 122 may be capable of sending emails and/or instant messages, conducting a video call or an audio call, and/or running an internet browsing functionality to browse and/or provide inputs to a website associated with water utility entity 102. Further, customer 116 may interact with water utility entity 102 by providing a written feedback 124.

Further, the customer such as customer 112, customer 114, customer 116, and customer 118 may avail of the water utility services from the water utility entity. To avail the water utility services, the customer may have to pay the water bills, for example every month, depending on bill cycle. If the customer fails to pay the water bills within a stipulated period, the water bills may become outstanding debt.

In order to recover the outstanding debt, the water utility entity 102 may initiate a plurality of collection actions to recover the outstanding debt from the customer such as customer 112, customer 114, customer 116, and customer 118. The plurality of collections comprise short messaging service (sms), outbound dial, reminder letter, final notice, legal letter, in-house litigation, courts, and sending debt collection agent.

The water utility entity 102 may, apart from agent 128 and IVR system 130, further include a customer database 132. The customer database 132 may maintain customer specific information like customer profile, demography, segmentation of the customers based on their profile, previous collection actions and their outcome. Further, the customer database 132 stores the debits (invoices raised against dues) and corresponding credits (collections against the billing).

Additionally, the water utility 102 may include a control system 134 that may control any processing operations performed by the water utility 102. For example, control system 134 may perform processing activities to provide the water utility services, store information in the customer database 134, or any other processing activities required to be performed by the water utility 102 to maintain its operations.

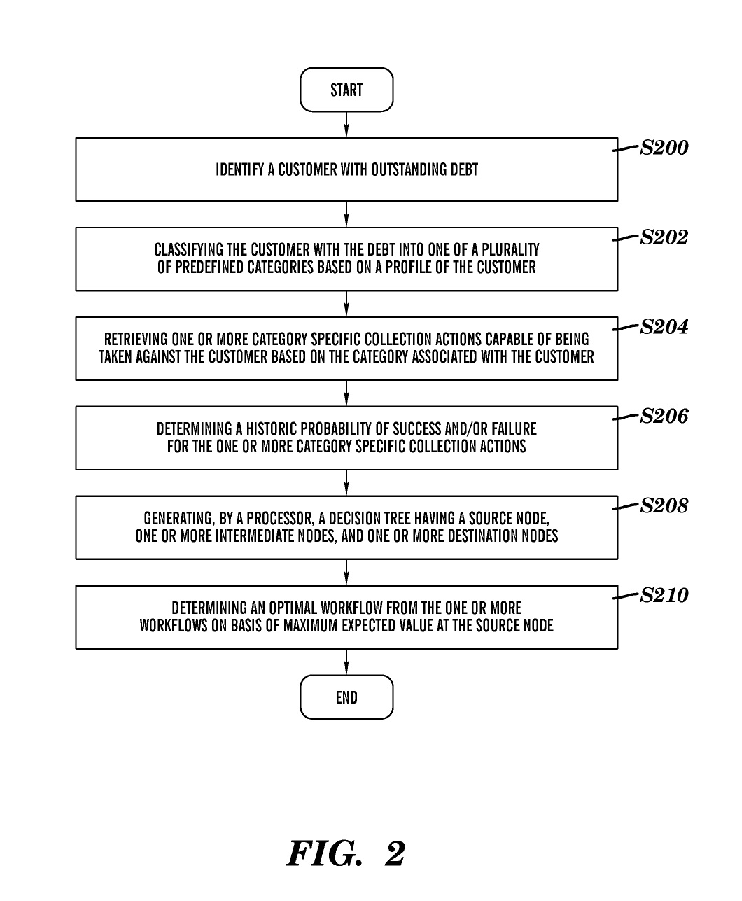

FIG. 2 illustrates a flowchart for optimizing process of outstanding debt collection in accordance with some embodiments. At step S200, a processor in communication with the water utility entity 102, may identify the customer with an outstanding debt. Customer with the outstanding debt may mean a person (includes a legal entity like company) who has failed to pay the water bills within a stipulated time period.

Once the customer with the outstanding debt has been identified, next step is to classify the customer with the debt into one of a plurality of predefined categories based on a profile of the customer (S202). The profile of the customer may be extracted from the customer database 132 and comprises the following data entities pertaining to the profile of the customer.
Postal code of customer premise
Property type-individual/apartment
Home owner/Tenant
Charge basis—metered/unmetered
Payment method—cheque/electronic clearing service (ECS)
Customer's other property details (not including this premise)
Payment history of other property including their corresponding invoices and payments.

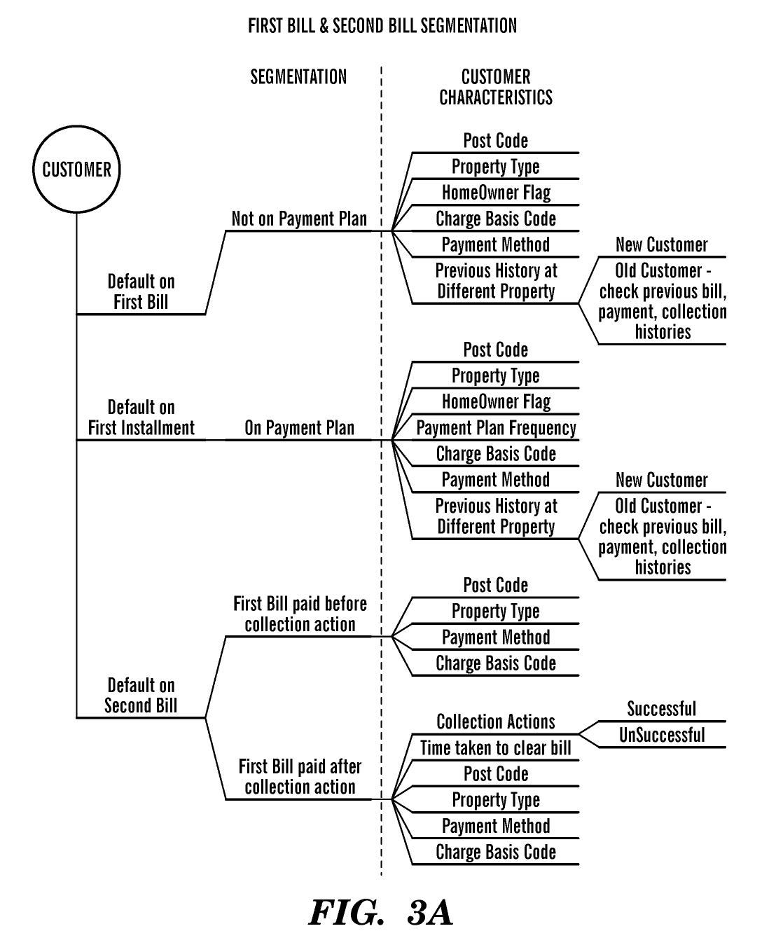

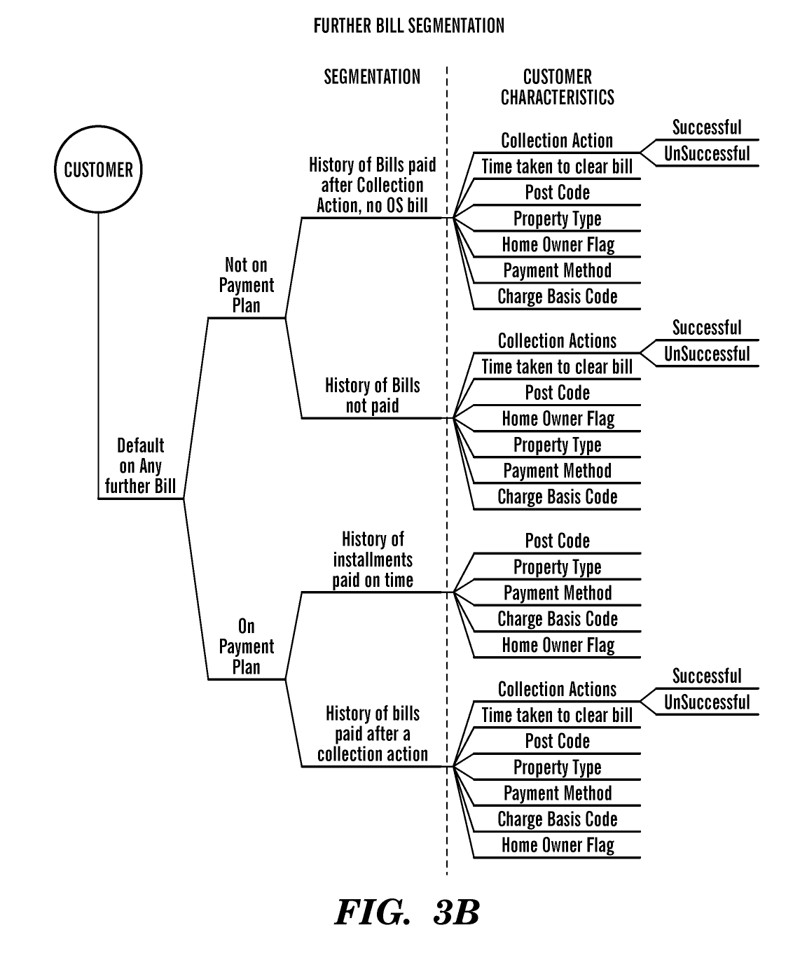

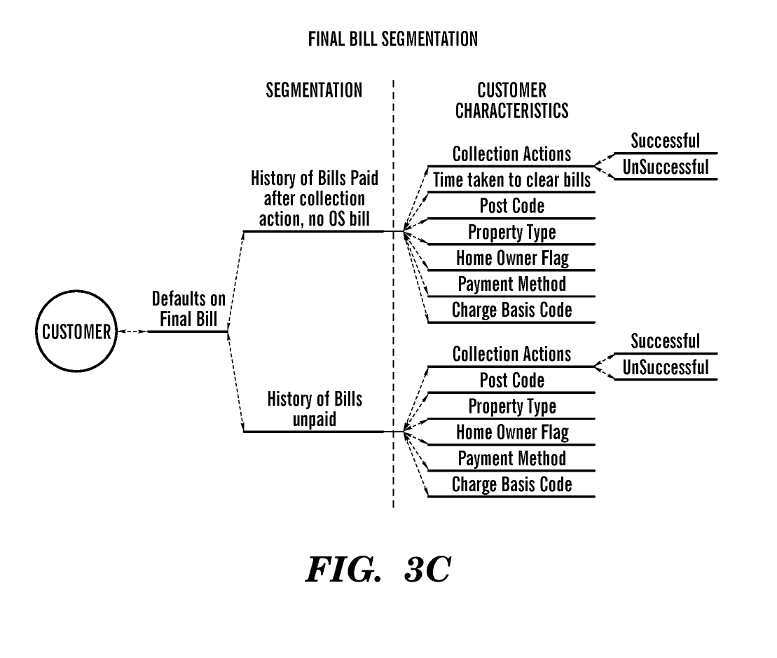

Each customer may be classified under the specific category for purpose of evaluating history of payments and responses to collection actions that helps in arriving at the probability of success of a specific collection action. Detailed method of classification of the customer into a particular category is illustrated in FIG. 3 in accordance with some embodiments.

Referring to FIG. 3A, a customer is classified into one of three categories. The three categories may be default on the first bill, default on the first installment, and default on second bill. The default on the first bill may be because that the customer is not on the payment plan. Not on payment plan implies that customer has not committed to making regular and periodic payments to the water utility entity 102 and the implicit understanding is that the customer would pay the whole bill amount once the bill is received as per the billing cycle which could be monthly or quarterly or half yearly or annually. This would indicate a segment of customers whose probability is higher for defaulting on their bills as they have not indicated to the water utility entity 102 to make periodic payments. The existence or lack of existence of payment plan is used as a segmentation category variable that indicates propensity to pay or default. There may be different arrangements for charging the customer. It might be possible that the customer has agreed to pay on a monthly or weekly basis on a specific day of month or week in installments. Such an arrangement may come within the ambit of the definition of the “payment plan”. So the other category may the default on the first installment. Even after default on the first installment, the customer is still on the payment plan. Then there is default on the second bill which is further classified into two categories. The implicit assumption is that customers won't be offered payment plan facility by the water utility entity 102 if they have defaulted in making payment as per their payment plan installment schedules. The default on second bill can be further split and analyzed based on two categories being the “first bill paid before collection action” and “first bill paid after collection action” which would indicate the customers propensity to pay their second bill on a timely basis. There is further classification on the basis of customer characteristics or the profile of the customer as discussed earlier. Once the customer is classified into one of the categories, the probability of success or failure of different collection actions is determined.

Referring to FIG. 3B, the customer is classified into “not on payment plan” and “on payment plan”. “Not on payment plan” is further classified into “history of bills paid after collection action” and “history of bills not paid.” There is further classification on the basis of the profile of the customer. After classifying the customer into a particular category, the probability of success or failure of different collection actions is determined.

Referring to FIG. 3C, the customer defaults on the final bill which is sent to the customer when he is moving out of his premises. If the customer defaults on the final bill. It is classified on basis of “history of bills paid after collection action” and “history of bills unpaid”. This is followed by further classification on the basis of the profile of the customer. After classifying the customer into a particular category, the probability of success or failure of different collection actions is determined. The process of classification of a customer in a particular category is dynamic and is updated continuously.

At step S204, one or more category specific collections that can be taken against the customer may be retrieved based on the category associated with the customer. The collection actions that can be taken against the customer may be dependent on the last collection action taken against the customer. The selection of collection actions may also be dependent on the probability of success and/or failure of the collections actions for the category to which the customer belongs to. Further, the sequence of the collection actions and the collection actions that can be taken for a particular category are constrained by business and legal factors. Legal factors imply that the certain collection actions have to be performed in a particular sequence. For example, soft collections actions may have to precede hard collection actions like soft reminder may be sent before sending the legal letter. Further, the number of collection actions that may be initiated against a particular customer belonging to a particular category is decided by business factors. For example, company may have a policy of not making an outbound dial to recover the outstanding debt. Another company may have a policy of going directly to courts after the legal letter has been served to the customer. Following table expounds the dependency of the sequence of the collection actions and the collection actions that can be taken for a particular category on the business and legal factors.

TABLE 1
An exemplary list of collection actions initiated against
the outstanding debt based on the last collection actions.
Options Matrix for Possible Collection Actions

| | | Possible Next Action | | | | | | | | | |
|---|---|---|---|---|---|---|---|---|---|---|---|
| | | | | | | | | | | Debt | |
| | | | | Outbound | Reminder | Final | Legal | Inhouse | | Collection | Write |
| Last Event/Action | | Wait | SMS | Dial | Letter | Notice | Letter | Litigation | Courts | Agent | Off |
| | Cost | 0.05% | $0.50 | $1.00 | $1.50 | $1.50 | $2.00 | $5.00 | $100 | 5% | 110% |
| | Wait Period in | 7 | 7 | 7 | 14 | 14 | 21 | 21 | 30 | 30 | 365 |
| | days after | | | | | | | | | | |
| | Precious Action | | | | | | | | | | |
| | (example only) | | | | | | | | | | |
| | Min debt Age in | 7 | 7 | 7 | 14 | 23 | 30 | 60 | 180 | 120 | 730 |
| | days criteria | | | | | | | | | | |
| Bill Outstanding | | Y | Y | Y | Y | Y | | | | | |
| SMS | | | | Y | Y | Y | | | | | |
| Outbound Dial | | | | | Y | Y | Y | | | | |
| Reminder Letter | | | Y | | | Y | Y | | | | |
| Final Notice | | | Y | Y | | | Y | Y | | Y | |
| Legal Letter | | | | Y | | | | Y | Y | Y | |
| Inhouse Litigation | | | | | | | | | Y | Y | |
| Courts | | | | | | | | | | | Y |
| Debt Collection Agent | | | | | | | | | | | Y |

In the above table, last collection action taken for the particular category and the number of possible collection actions that can be taken are illustrated. For example, if the last collection action is SMS, possible collections that can be taken may be outbound dial, reminder letter, and final notice. Similarly, if the last collection action is reminder letter, possible collections that can be taken may be SMS, final letter, and legal notice. If the last collection is final notice, possible collections that can be taken may be SMS, outbound dial, legal letter, in-house litigation, and sending the debt collection agent.

Further, cost associated with the different collection actions is also illustrated. For example, the cost of waiting is 0.05% of the outstanding debt. The cost of sending a SMS is $0.5. Further, the cost of sending at debt collection agent is 5% of the outstanding debt and the cost of writing off debt is 110% of the outstanding debt.

Additionally, time period between two collection actions for which the water utility entity 102 has to wait has been mentioned. For example, time period between the SMS and outbound dial may be 7 days. Similarly, time period between final notice and the legal letter may be 21 days. Additionally, there is condition of minimum debt age criterion before a particular collection action can be taken. For example, reminder letter may be sent after the debt age is 14 days. Similarly, the debt may be written off only after the minimum age of the outstanding debt is 730 days.

At step S206, a probability of success and/or failure for the one or more

collection actions belonging to a category may be determined. All previous transactions specific to a collection action for the category and outcome of this collection action may be retrieved. For instance if there was an outstanding against a particular customer and a collection action (example—legal letter) was taken for any customer in the customer category and if there was a credit (payment) transaction immediately after this collection action, then the outcome of the collection action will be considered a success. If there was no credit or another debit or another collection action immediately succeeding this collection action, then this collection action will be considered as a failure. The ratio of all such successes divided by the total number of collection actions against this customer segment will be the probability of success of this collection action for this customer segment. The total number collection actions minus the number of successful collection actions divided by the total number of collection actions against this customer segment will be the probability of failure of this collection action for this customer segment.

At step S208, last collection action taken for debt collection may be identified. Subsequently, a decision tree for the last collections actions may be generated by a processor. Before generating the decision tree, the collection actions that can be taken subsequent to a specific collection action that was last performed against an outstanding debt may be configured by a user using a user interface. The configuration may be based on the business factors as explained earlier with respect to table 1. The user will configure as a onetime activity to generate a plurality of workflows. Below table illustrates the user interface through which the user configure the set of collection action that will follow a specific collection action that was last performed.

TABLE 2
An exemplary user interface to configure
the set of collection actions.
Debt Management WorkFlow

| | | Next Action | | | | | | | | | |
|---|---|---|---|---|---|---|---|---|---|---|---|
| | | | | | | | | | Debt | | |
| | | | | Outbound | Reminder | Final | Legal | Inhouse | Collection | | |
| Last Event/Action | | Wait | SMS | Dial | Letter | Notice | Letter | Litigation | Agent | Courts | |
| | Cost | 0% | 1 | 1 | 2 | 2 | 2 | 5 | 5% | 100 | 110% |
| | Wait Period | 7 | 7 | 7 | 14 | 14 | 21 | 21 | 30 | 30 | 355 |
| | in days after | | | | | | | | | | |
| | Previous Action | | | | | | | | | | |
| | Min debt Age | 7 | 7 | 7 | 14 | 21 | 30 | 60 | 120 | 180 | 130 |
| | in days criteria | | | | | | | | | | |
| Bill Outstanding | | [symbol] | [symbol] | [symbol] | [symbol] | [symbol] | [symbol] | [symbol] | [symbol] | [symbol] | [symbol] |
| Wait | | | [symbol] | [symbol] | [symbol] | [symbol] | [symbol] | [symbol] | [symbol] | [symbol] | [symbol] |
| SMS | | [symbol] | | [symbol] | [symbol] | [symbol] | [symbol] | [symbol] | [symbol] | [symbol] | [symbol] |
| Outbound Dial | | [symbol] | [symbol] | | [symbol] | [symbol] | [symbol] | [symbol] | [symbol] | [symbol] | [symbol] |
| Reminder Letter | | [symbol] | [symbol] | [symbol] | | [symbol] | [symbol] | [symbol] | [symbol] | [symbol] | [symbol] |
| Final Notice | | [symbol] | [symbol] | [symbol] | [symbol] | | [symbol] | [symbol] | [symbol] | [symbol] | [symbol] |
| Legal Letter | | [symbol] | [symbol] | [symbol] | [symbol] | [symbol] | | [symbol] | [symbol] | [symbol] | [symbol] |
| Inhouse Litigation | | [symbol] | [symbol] | [symbol] | [symbol] | [symbol] | [symbol] | | [symbol] | [symbol] | [symbol] |
| Debt Collection Agent | | [symbol] | [symbol] | [symbol] | [symbol] | [symbol] | [symbol] | [symbol] | | [symbol] | [symbol] |
| Courts | | [symbol] | [symbol] | [symbol] | [symbol] | [symbol] | [symbol] | [symbol] | [symbol] | | [symbol] |
| Write-Off | | [symbol] | [symbol] | [symbol] | [symbol] | [symbol] | [symbol] | [symbol] | [symbol] | [symbol] | |
| Submit | | | | | | | | | | | |

The decision tree may be composed of a plurality of workflows. Each of the plurality of workflows may comprise one or more collection actions. The decision tree may have a source node, one or more intermediate nodes, and one or more destination nodes. The source node, the one or more intermediate nodes, and the one or more destination nodes may represent the one or more category specific collection actions. The source node, the one or more intermediate nodes and the one or more destination nodes may constitute one or more workflows.

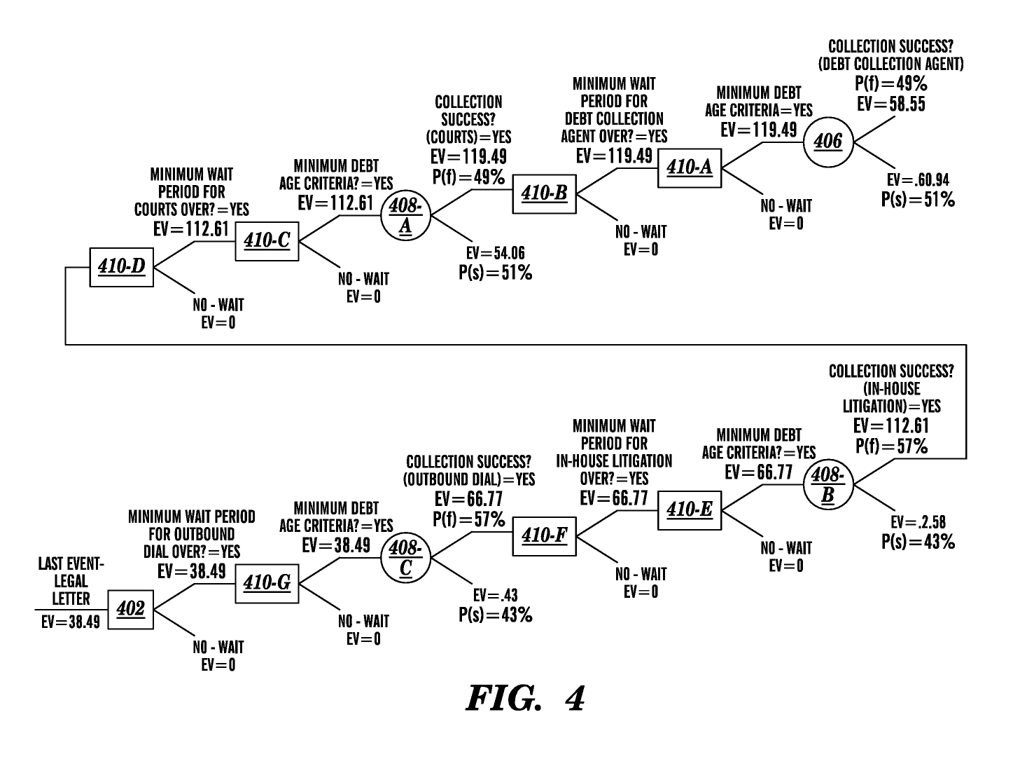

At step S210, an optimal workflow from the one or more workflows is determined on basis of maximum expected value at the source node. The maximum expected value is based on cost associated with the one or more category specific collection actions and probability of success and/or failure of the one or more category specific collection actions. In an exemplary embodiment, determination of the optimal workflow is explained in FIG. 4.

Referring to FIG. 4, an exemplary workflow out of a plurality of workflows is shown in accordance with some embodiments. The workflow may comprise

a source node 402, one or more intermediate nodes, and a destination node 406. Each of the source node 402, the one or more intermediate nodes, and the destination node 406 may be associated with a collection action, for example, legal letter, outbound dial, in-house litigation, courts, and debt collection agent. The one or more intermediate nodes, further may comprise chance nodes (408-A, 408-B, 408-C . . . ) represented by circle and decision nodes (410-A, 410-B . . . ) represented by square. The decision nodes may pertain to whether the wait period for performing a collection action is over or not and the debt age criterion. The chance node 408 may pertain to probability of success and the probability of failure of a collection action. The source node 402 may pertain to a last collection action/last event. The source node 402 and the destination node 406 may be one of a chance node and a decision node.

Maximum expected value at the source node 402 is calculated by tracing backwards from the destination node 406 towards the source node 402. As shown in FIG. 4, outstanding debt in the exemplary scenario is 269.94 and the destination node 406 represents the collection action of sending debt collection agent. Referring to table 1, the cost of sending debt collection agent is 5% of the outstanding debt and 106 is the cumulative cost of the all the collections actions taken before the collection action of the debt collection agent. Further, probability of failure (p(f)) of sending debt collection agent is 49% and probability of the success(p(s)) is 51%. Expected value at the destination node 406 is obtained by the following formula:

EV=((106+5% of 269.94)*49%)+((106+5% of 269.94)*51%)=119.49

This expected value (EV) is traversed backwards to preceding decision node 410-A depending on whether the minimum debt age period is over or not. If the minimum debt age is not over, then there may be waiting period and EV may be zero. If the minimum debt age is over, the above calculated EV may be traversed backwards to the preceding decision node 410-A. Further, it is decided whether the EV 119.49 may be traversed to the decision node 410-B based on whether the minimum period for the collection action of debt collection agent is over or not. If the minimum period is not over, then there may be waiting period and EV may be zero. If the minimum period is over, the above calculated EV may traverse backwards to the preceding decision node 410-B.

Continuing with the above exemplary scenario, the next node is chance node 408-A which is related to the probability of success or failure of the collection action courts. New expected value is calculated at the chance node 408-A. Referring to table 1, the cost of collection action courts is $100 and $106 is the cumulative cost of the all the collections actions taken before the collection action courts and the cost of the courts. Further, probability of failure (p(f)) of courts is 49% and probability of the success (p(s)) is 51%. Expected value at the chance node 408-A is obtained by the following formula:

$$EV 1 at the chance node 408 \text{-} A = ( EV at the destination node 406 * probability of failure ) + ( cumulative cost * probability of success ) = ( 119.49 * 49 \% ) + ( 106 * 51 \% ) = 112.61$$

As discussed earlier, EV1 is traversed backwards to preceding decision node 410-C depending on whether the minimum debt age period is over or not. If the minimum debt age is not over, then there may be waiting period and EV may be zero. If the minimum debt age is over, the above calculated EV1 may be traversed backwards to the preceding decision node 410-C. Further, it is decided whether the EV1 112.61 may be traversed to the decision node 410-D based on whether the minimum period for the collection action courts is over or not. If the minimum period is not over, then there may be waiting period and EV may be zero. If the minimum period is over, the above calculated EV1 may traverse backwards to the preceding decision node 410-D.

Continuing with the above exemplary scenario, the next node is chance node 408-B which is related to the probability of success or failure of the collection action in-house litigation. New expected value is calculated at the chance node 408-B. Referring to table 1, the cost of collection action in-house litigation is $5 and $6 is the cumulative cost of the all the collections actions taken before the collection action in-house litigation and the cost of the in-house litigation. Further, probability of failure (p(f)) of in-house litigation is 57% and probability of the success (p(s)) is 43%. Expected value at the chance node 408-B is obtained by the following formula:

$$EV 2 at the chance node 408 \text{-} B = ( EV 1 * probability of failure ) + ( cumulative cost * probability of success ) = ( 112.61 * 57 \% ) + ( 6 * 43 \% ) = 66.77$$

As discussed earlier, EV2 is traversed backwards to preceding decision node 410-E depending on whether the minimum debt age period is over or not. If the minimum debt age is not over, then there may be waiting period and EV2 may be zero. If the minimum debt age is over, the above calculated EV2 may be traversed backwards to the preceding decision node 410-E. Further, it is decided whether the EV2=66.77 may be traversed to the decision node 410-F based on whether the minimum period for the collection action courts is over or not. If the minimum period is not over, then there may be waiting period and EV2 may be zero. If the minimum period is over, the above calculated EV2 may traverse backwards to the preceding decision node 410-F.

Continuing with the above exemplary scenario, the next node is chance node 408-C which is related to the probability of success or failure of the collection action outbound dial. New expected value is calculated at the chance node 408-C. Referring to table 1, the cost of collection action outbound dial is $1. Further, probability of failure ((p(f)) of outbound dial is 57% and probability of the success (p(s)) is 43%. Expected value at the chance node 408-C is obtained by the following formula:

$$EV 3 at the chance node 408 \text{-} C = ( EV 2 * probability of failure ) + ( cost * probability of success ) = ( 66.77 * 57 \% ) + ( 1 * 43 \% ) = 66.77 = 38.49$$

As discussed earlier, EV3 is traversed backwards to preceding decision node 410-G depending on whether the minimum debt age period is over or not. If the minimum debt age is not over, then there may be waiting period and EV2 may be zero. If the minimum debt age is over, the above calculated EV3 may be traversed backwards to the preceding decision node 410-E. Further, it is decided whether the EV3=66.77 may be traversed to the decision node 410-G based on whether the minimum period for the collection action courts is over or not. If the minimum period is not over, then there may be waiting period and EV3 may be zero. If the minimum period is over, the above calculated EV3 may traverse backwards to the source node 402.

Similarly, following the above discussed method, expected value for the workflow for all other collection actions may be calculated. The workflow with maximum expected value at the source node 402 may be determined and the workflow may be the optimal workflow. The collections actions constituting the optimal workflow may be performed in a sequence starting with the last collection taken as the source node 402 and ending with the destination node 406. This performance of collections actions may provide the maximum probability of success of collections actions for a particular category. Process of generation of workflows is dynamic and is updated continuously.

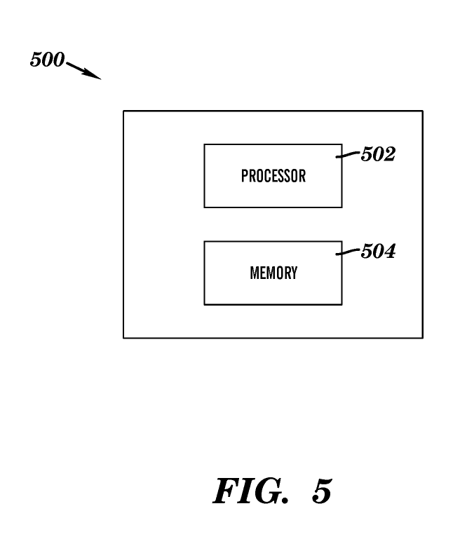

FIG. 5 is a block diagram of a system 500 for optimizing process of outstanding debt collection in accordance with some embodiments. In some embodiments, the system 500 may form a part of the water utility entity such as water utility entity 102. The system may include a processor 502 and a memory 504. The memory 504 of the system 500 may include instructions that are executable by processor 502 to optimize process of outstanding debt collection in accordance with some embodiments of this disclosure.

The processor 502 may identify a customer with a debt. Further, the processor 502 may classify the customer with the debt into one of a plurality of predefined categories based on a profile of the customer. This is followed by retrieving one or more category specific collection actions capable of being taken against the customer based on the category associated with the customer. After retrieving the category specific collection actions, the processor 502 may determine a historic probability of success and/or failure for the one or more category specific collection actions. Then the processor 502 generates a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows. Subsequently, an optimal workflow is from the one or more workflows is determined on basis of maximum expected value at the source node, the maximum expected value based on cost associated with the one or more category specific collection actions and probability of success and/or failure of the one or more category specific collection actions.

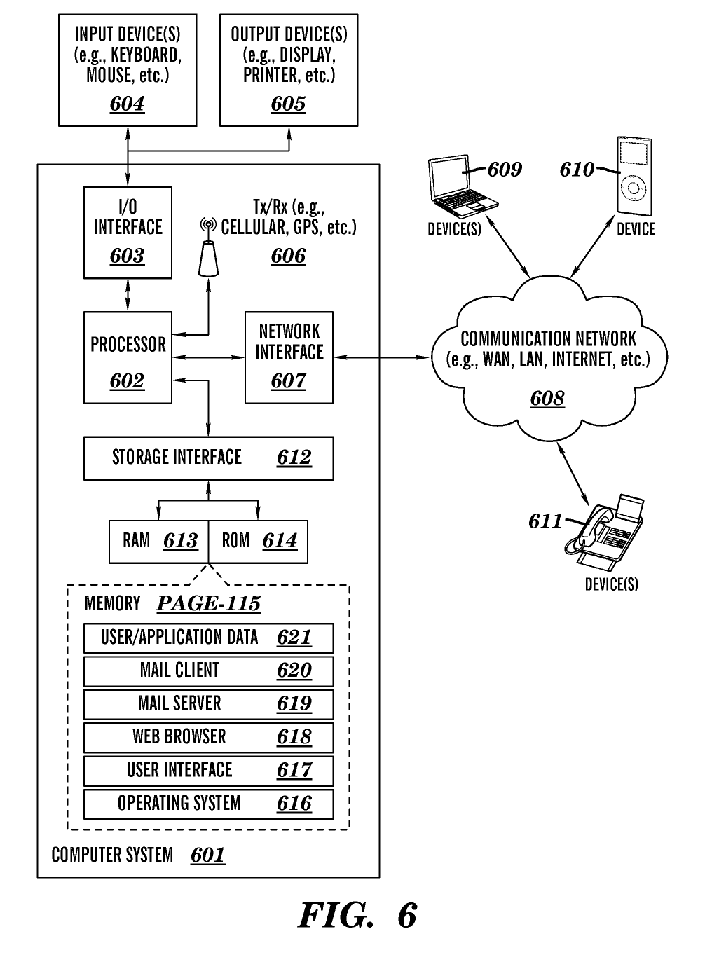

FIG. 6 is a block diagram of an exemplary computer system for implementing embodiments consistent with the present disclosure. Variations of computer system 601 may be used for implementing any of the devices presented in this disclosure. Computer system 401 may comprise a central processing unit (“CPU” or “processor”) 602. Processor 602 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 610, 611, and 612. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It should be apparent to a person skilled in the art that the method and the system recited in the present disclosure may equally apply to any utility providing entity and not only to water utility entity. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for optimizing debt collection from a customer, the method comprising:
identifying, by a utility management computing device, a customer with a debt;
classifying, by the utility management computing device, the customer with the debt into one of a plurality of predefined categories based on a profile of the customer;
retrieving, by the utility management computing device, one or more category specific collection actions capable of being taken against the customer based on the category associated with the customer;
determining, by the utility management computing device, a historic probability of success and/or failure for the one or more category specific collection actions;
generating, by the utility management computing device, a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows; and
determining, by the utility management computing device, an optimal workflow from the one or more workflows on basis of maximum expected value at the source node, the maximum expected value based on cost associated with the one or more category specific collection actions and probability of success and/or failure of the one or more category specific collection actions.

2. The method of claim 1 further comprising retrieving, by the utility management computing device, last collection action taken subsequent to the outstanding balance.

3. The method of claim 1 wherein the source node represents the last collection action taken.

4. The method of claim 1 wherein the maximum expected value at the source node is calculated by tracing backwards from the one or more destination nodes towards the source node.

5. The method of claim 1 wherein the expected value for the one or more intermediate nodes decreases while tracing backwards from the one or more destination nodes towards the source node.

6. The method of claim 1 wherein execution of the optimal workflow comprises moving from the source node to one of the one or more destination nodes.

7. The method of claim 1 wherein the profile of the customer is generated based on at least one of a payment history data, output of a collection action, time taken to clear previous bills, payment method, and a demographic data.

8. The method of claim 1 wherein sequence of the one or more collection actions against the customer is fixed based on one or more business and legal constraints.

9. The method of claim 1 wherein the predefined category associated with the customer is dynamic and is updated continuously.

10. A utility management computing device comprising:
a processor;
a memory, wherein the memory coupled to the processor which are configured to execute programmed instructions stored in the memory comprising:
identify a customer with a debt;
classify the customer with the debt into one of a plurality of predefined categories based on a profile of the customer;
retrieve one or more category specific collection actions capable of being taken against the customer based on the category associated with the customer;
determine a historic probability of success and/or failure for the one or more category specific collection actions;
generate a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows;
determine an optimal workflow from the one or more workflows on basis of maximum expected value at the source node, the maximum expected value based on the cost associated with the one or more category specific collection actions and probability of success and/or failure of the one or more category specific collection actions.

11. The device of claim 10, wherein a last collection action taken is retrieved subsequent to the outstanding balance.

12. The device of claim 10, wherein the source node represents the last collection action taken.

13. The device of claim 10, wherein the maximum expected value at the source node is calculated by tracing backwards from the one or more destination nodes towards the source node.

14. The device of claim 10, wherein the expected value for the one or more intermediate nodes decreases while tracing backwards from the one or more destination nodes towards the source node.

15. The device of claim 10, wherein execution of the optimal workflow comprises moving from the source node to one of the one or more destination nodes.

16. The device of claim 10, wherein the profile of the customer is generated based on at least one of a payment history data, output of a collection action, time taken to clear previous bills, payment method, and a demographic data.

17. The device of claim 10, wherein sequence of the one or more collection actions against the customer is fixed based on one or more business and legal constraints.

18. The device of claim 10, wherein the predefined category associated with the customer is dynamic and is updated continuously.

19. A non-transitory computer readable medium having stored thereon instructions for optimizing debt collection from a customer comprising executable code which when executed by a processor, causes the processor to perform steps comprising:
identifying a customer with a debt;
classifying the customer with the debt into one of a plurality of predefined categories based on a profile of the customer;
retrieve one or more category specific collection actions capable of being taken against the customer based on the category associated with the customer;
determining a historic probability of success and/or failure for the one or more category specific collection actions;
generating a decision tree having a source node, one or more intermediate nodes, and one or more destination nodes, the source node, the one or more intermediate nodes, and the one or more destination nodes representing the one or more category specific collection actions, and the source node, the one or more intermediate nodes and the one or more destination nodes constituting one or more workflows;
determining an optimal workflow from the one or more workflows on basis of maximum expected value at the source node, the maximum expected value based on the cost associated with the one or more category specific collection actions and probability of success and/or failure of the one or more category specific collection actions.

20. The medium of claim 19 wherein:
a last collection action taken is retrieved subsequent to the outstanding balance;
the source node represents the last collection action taken;
the maximum expected value at the source node is calculated by tracing backwards from the one or more destination nodes towards the source node;
the expected value for the one or more intermediate nodes decreases while tracing backwards from the one or more destination nodes towards the source node;
the execution of the optimal workflow comprises moving from the source node to one of the one or more destination nodes;
the profile of the customer is generated based on at least one of a payment history data, output of a collection action, time taken to clear previous bills, payment method, and a demographic data;
the sequence of the one or more collection actions against the customer is fixed based on one or more business and legal constraints; and
the predefined category associated with the customer is dynamic and is updated continuously.
